(19) United States
(12) Patent Application Publication
(10) Pub. No.: US 2009/0280342 A1
(43) Pub. Date: Nov. 12, 2009

(54) Method for production of a laminated multilayer composite, a laminated multilayer composite, and use thereof

(75) Inventor: Ohannes Minnetian, Eschenbach (CH)

Correspondence Address: HOFFMANN & BARON, LLP, 6900 JERICHO TURNPIKE, SYOSSET, NY, 11791, US

(73) Assignee: OVD Kinegram AG, Zug (CH)

(21) Appl. No.: 12/308,871

(22) PCT Filed: Jun. 22, 2007
(86) PCT No.: PCT/EP2007/005506

§ 371 Date: May 1, 2009

(30) Foreign Application Priority Data
Jun. 27, 2006 (DE) 10 2006 029 397.5

(51) Int. Cl. B32B 27/06; C09J 5/02; B32B 27/08

(52) U.S. Cl. 428/500; 156/322

(57) ABSTRACT

The invention concerns a process for the production of a laminated layer composite including a carrier film which has at least one polymer layer portion, in particular of polyvinyl chloride or polyethylene terephthalate, at least one security element applied to the at least one polymer layer portion, and at least one plastic film, wherein the carrier film is annealed prior to application of the security element at least in a region in which the security element is applied. The invention further concerns a layer composite produced in accordance therewith and the use thereof in the form of a card or the like.

The invention concerns a process for the production of a laminated layer composite including a carrier film which has at least one polymer layer portion, in particular of polyvinyl chloride or polyethylene terephthalate, at least one security element applied to the at least one polymer layer portion, and at least one plastic film. The invention further concerns layer composites produced with that process and use thereof.

DE 694 15 547 T2 discloses such laminated layer composites in the form of security cards and the manufacture thereof. In that case a security card includes a transparent or opaque carrier, a transparent casing layer and a security image disposed between the carrier and the casing layer. The carrier and the casing layer are laminated together or fused to each other directly, without the provision of an adhesive layer therebetween. In that case the carrier is inter alia in the form of a polyvinyl chloride film and the casing layer is in the form of an amorphous co-polyester film. The security image can include pearlescent pigments in a transparent binder, holograms, or microstructured surfaces providing special optical effects such as for example holographic images or diffraction effects. In addition DE 694 15 547 T2 in a comparative example describes the lamination of two layers of polyvinyl chloride of a thickness of 250 μm each, which are laminated at a temperature of 140° C. over a period of 5 minutes. The use of two layers of polyvinyl chloride as a carrier and a casing layer is in that case viewed as inappropriate because of the long lamination time required of 5 minutes.

Because of the low material costs of in particular polyvinyl chloride however that material is of steadily increasing interest as a material for cards of any kind, as the manufacture of cards which include security elements such as for example identity cards, bank cards, credit cards, identification cards or the like are subject to an enormous cost pressure. It is known for such cards to be equipped with security elements in the form of a hologram, a Kinegram® or the like. The security elements have specific optical effects which are dependent on the viewing angle and which can be checked with the human eye without any accessory aid. It will be noted however that manufacture involves a considerable level of technological complication. The presence of such a security element with the corresponding optical effects is assessed as an authenticity criterion, that is to say the authenticity of the card is judged from the presence of such a security element.

It has been found however that the step of laminating carrier films, in particular of polyvinyl chloride, to which a security element has been applied, is not without its problems.

A carrier film can be provided with a security element in different ways. A preferred, particularly fast and clean process for applying the security element involves the transfer film technology which is already sufficiently known in relation to the production of security elements, in the field of cards. A transfer film usually includes a transfer web on which there is detachably arranged a thin transfer layer portion which is not self-supporting and which is transferred onto the carrier film over the full surface area involved or in region-wise manner by means of a possibly heated punch. In that case the transfer layer portion is usually fixed on the carrier film by means of an adhesive, wherein the adhesive is activated by means of heat, pressure, radiation and so forth or a combination thereof. In the hot embossing process a heated punch provides for activation of a hot melt adhesive layer which fixes the heated regions of the transfer layer portion to the carrier film. Upon subsequent removal of the carrier web of the transfer film from the carrier film only the regions of the transfer layer portion, that are fixed by means of hot adhesive, remain on the carrier film, while adjacent, unheated regions of the transfer layer portion are removed with the carrier web.

A security element can however also be applied to the carrier film by means of a self-supporting film, in particular in the form of a lamination film or a portion thereof.

After application of a security element to a carrier film, in particular by embossing, the security element can be readily recognised and is optically perfect. After over-lamination of the carrier film with a further plastic film however an orange peel effect is presented on the security element, such that the security element appears wavy and undulating over its entire area or it appears to be applied to a surface involving severe surface roughness. The optical appearance of the security element is seriously impaired, in part to such a degree that its information content becomes unrecognisable. In that respect thin security elements which are applied to the carrier film in a thickness in the range of 3 μm to about 100 μm are particularly affected.

That effect can however also occur when using other carrier films instead of PVC such as for example in the case of carrier films of polyethylene terephthalate, polyethylene naphthalate, PET-G, PC, ABS, compounds of those plastics inclusive of PVC, layer composites of those plastics materials with paper and/or Teslin®.

Therefore the object of the invention is to provide an improved process for the production of a laminated layer composite without the orange peel effect.

That object is attained by a process for the production of a laminated layer composite including a carrier film which has at least one polymer layer portion, in particular of polyvinyl chloride or polyethylene terephthalate, at least one security element applied to the at least one polymer layer portion, and at least one plastic film, in that the carrier film is annealed prior to application of the security-element at least in a region in which the security element is applied.

Annealing of the carrier film or at least a region of the carrier film, to which a security element is to be applied, clearly causes a local reduction in the internal stress in the carrier film. While a carrier film which has not been previously annealed, in particular comprising the materials already referred to above such as PVC, PET, PEN, ABS and so forth, in the region of a security element after lamination with a further plastic film and cooling of the layer composite exhibits the above-described orange peel effect, that is no longer the case or is the case only to an extremely slight extent which optically is no longer a problem, when using a previously annealed carrier film after the lamination and cooling steps. Again heating a carrier film, in particular of PVC or PET, upon lamination with a further plastic film, thus no longer adversely affects the appearance of the security element or has an only immaterial adverse effect thereon.

In that respect it is sufficient in some cases if the carrier film is annealed prior to application of the security element at least in a region in which the security element is applied. That can be effected for example by pre-embossing with a heated punch which is pressed thereagainst at least in the region in which the security element is to be applied. Preferably however the entire carrier film is annealed prior to application of the security element.

The annealing operation can be effected by means of IR radiating devices, heated rollers, plates or belts, feeding a flow of hot gas or the like and combinations thereof. In that case annealing of the carrier film can be effected with or without the carrier film being subjected to the action of pressure. In addition the carrier film can be effected directly after manufacture or shaping thereof in a directly following process step, that is to say in “inline” relationship, or alternatively at a later time, that is to say “offline”, at the consumer of the carrier film.

Preferably the carrier film is annealed at a temperature which is in a range of 10° below the softening temperature to above the softening temperature of the at least one polymer layer portion. The higher the temperature in the annealing operation, the correspondingly better is elimination of the internal stresses in the polymer layer portion of the carrier film, which were presumably introduced during manufacture thereof. It is assumed at the present time that in particular production processes for polymer layer portions such as calendering or extrusion in which the softened plastic material is cooled under a heavy compression or tensile loading lead to high internal stresses. Heating of the carrier film is effected in the annealing operation only to such an extent that the external shape of the carrier film is at least substantially retained.

It has proven desirable if the carrier film is annealed at a temperature in the range of 100 to 160° C.

It has further proven advantageous if the carrier film is annealed under the action of pressure in the range of 500 to 4000 kN/m². The pressure is increased in particular with an increase in the temperature in annealing of the carrier film and is then kept constant over a given period of time.

It has proven desirable if the carrier film is maintained at a temperature above a softening temperature of the respective plastic material at least in the region in which the security element is applied, at least over a period of 120 seconds, in particular over a period of at least 240 seconds.

It has further proven desirable if the carrier film is annealed at a temperature which is below a softening temperature of the at least one polymer layer portion and in a range of up to 10° C. below a softening temperature of the at least one polymer layer portion. It has been found that annealing in that temperature range is already sufficient for the orange peel effect not to occur. That is all the more surprising as lamination of the carrier film with the security element and the plastic film is usually effected at a temperature above the softening temperature of the at least one polymer layer portion and it had been assumed that the laminating operation alone would already suffice to suitably anneal the carrier film. It will be noted however that this is not the case, but separate annealing of the carrier film prior to application of the security element is required.

Preferably in that respect the carrier film is kept at a temperature below the softening temperature of the at least one polymer layer portion and in a range of up to 10° C. below the softening temperature of the at least one polymer layer portion at least in the region in which the security element is applied, at least over a period of 120 seconds, in particular over a period of at least 240 seconds.

The at least one polymer layer portion of the carrier film can be formed from PVC-P or PVC-U, PET, PEN, ABS or compounds of those plastic materials inclusive of PVC.

The carrier film can be made up of a single polymer layer portion or a plurality of polymer layer portions or can be in the form of a composite of one or more polymer layer portions with paper and/or Teslin®.

Preferably the carrier film is selected to be in a thickness in the range of 12 μm to 1 mm.

It has proven desirable if the carrier film is cooled to a temperature below 50° C. before the security element is applied thereto.

It is further advantageous if the carrier film is cooled under the action of pressure in the range of 500 to 4000 kN/m². That makes it possible to form particularly smooth and optically perfect external surfaces for the laminated layer composite.

It is particularly preferred if the security element is applied by embossing, in particular hot embossing, or by adhesive, to a first and/or a second side of the carrier film. The carrier film embossing operation is effected quickly and inexpensively.

It is particularly preferred if the security element is applied to the carrier film in a thickness in the range of 3 μm to 100 μm, in particular in the range of 3 μm to 30 μm. If the security element is comparatively thick, for example of a thickness of 100 μm or more, it is preferable to provide suitable depressions or the like at the location at which the security element is to be inserted into the layer composite. Such measures are unnecessary however if the security element is provided in the form of a film over the entire surface area on the layer composite. In that case the security element can also be markedly thicker than 100 μm.

The security element itself preferably includes a plurality of layer portions. They are preferably provided by a transfer layer portion of a transfer film, wherein the security element is transferred from the transfer film onto the carrier film.

It is particularly preferred if the security element includes at least region-wise a metallic and/or a dielectric reflection layer. That can also involve thin film stacks comprising more than two layers for generating viewing angle-dependent colour change effects by means of interference. When there is a reflection layer in the layer structure of the security element the orange peel effect appear particularly strongly so that the improvement achieved with the process of the invention is particularly apparent. If interruptions in the form of characters, patterns or the like are provided in a metallic and/or dielectric reflection layer, that achieves an additional security effect. Such interruptions can be produced for example by means of laser personalisation. In that case, the laser can also be used to produce a marking through an optically variable element in a subjacent layer portion which is selected in specifically targeted fashion.

It is preferred if the security element includes a diffractive relief structure, in particular a hologram, a Kinegram® or a diffraction grating. It is further proven desirable if the security element has optically and/or optomagnetically machine-readable structures. An orange peel effect in the region of the security element adversely affects such diffractive or machine-readable structures to a particularly severe degree so that the improvement achieved according to the invention also becomes markedly visible or noticeable for such security elements.

It has proven desirable if the security element includes at least two layer portions, between which the diffractive relief structure is embedded, wherein at least one of the two layer portions, preferably both layer portions do not soften at the softening temperature of the polyvinyl chloride of the carrier film. If the relief structure of the security element is in a material like plastic material or lacquer which either naturally has a comparatively high softening temperature or is put into a state involving a high softening temperature at least after production of the relief structure, and if the films for production of the card by means of lamination are so selected that they have a lower softening temperature, that ensures that the relief structure of the security element is not detrimentally affected or is at least not substantially detrimentally affected by the temperature and pressure loadings occurring in the laminating operation. The materials for the films of the layer composite and for the layer portions of the security element are preferably so selected that the respective softening temperatures are sufficiently different during the laminating operation. Plastic materials, lacquers and so forth with a higher softening temperature, in particular thermosetting materials, hardened lacquers or the like are used as the preferred material in which the relief structure is present. For example crystalline polyester is particularly suitable. Lacquers hardened by crosslinking are also suitable. Suitable crosslinking reaction lacquers are for example radiation-hardenable lacquers, in particular radically and cationically hardening lacquers, in particular which harden under UV radiation, and lacquers which harden under blue light radiation.

The security element can include further layers which are possibly provided in pattern form or only in region-wise manner, in particular printed coloured layers, layers with additives or effect pigments having an optically variable effect such as luminescent or photochromic substances, liquid crystal layers, magnetic layers and so forth.

The security element can further be arranged in a window of the laminated layer composite and can thus be visible on both sides, for example of a card. In that respect an orange peel effect occurring would be visible on both sides of the layer composite and would disrupt the appearance.

Preferably at least one plastic film is laminated onto a first side and/or a second side of the carrier film. Thus a plurality of plastic films can be laminated onto one or both sides of the carrier film. It is particularly preferred, in regard to protecting the security element from mechanical stresses or chemical attacks, for at least one plastic film to be laminated at least onto the side of the carrier film, to which the security element has been applied. In that case the security element is embedded in the laminated layer composite. In that case the at least one plastic film and/or the carrier film is so selected that it/they is/are sufficiently transparent to permit checking of the security element by a viewing person, at least from one side of the laminated layer composite.

If the carrier film and the at least one plastic film are transparent and if moreover the security element is transparent entirely or region-wise, the optical appearance of a conventional card in which there are transparent windows can be achieved by means of opaque printing thereon. The security element with optical diffraction structures can be recognised in such a transparent window. If a security element which is opaque throughout is used, diffraction structures can possibly be provided in the same region of the layer composite on both sides of the security element, wherein the diffraction structures can be checked from both sides of the layer composite. In that case the optical diffraction effects on both sides can also provide different diffraction effects, for example different items of holographic information.

Thermoplastic materials which by their nature usually have a low softening temperature in the range of 65 to 150° C. are usually employed as the material for the films of the laminated layer composite. In regard to protecting the security element from forgery attempts or mechanical abrasive wear in later use of the laminated layer composite, it has proven desirable if the at least one plastic film is formed from polyvinyl chloride, polyester, polyethylene terephthalate, polycarbonate, PETG, ABS, polyethylene, polyethylene naphthalate or compounds of those plastic materials. The at least one plastic film can also be formed from different layer portions of those plastic materials and/or compounds.

In regard to inexpensive manufacture a plastic film formed from PVC is particularly preferred. In that case the plastic film of PVC can be used in annealed or unannealed form, wherein annealing can be effected in accordance with the conditions described hereinbefore for the carrier film.

It has proven desirable if a first plastic film is laminated onto a first side of the carrier film and a second plastic film is laminated onto a second side of the carrier film, wherein the first plastic film and the second plastic film are formed from the same material, in particular polyvinyl chloride.

A laminated layer composite produced by a process according to the invention includes a carrier film of polyvinyl chloride or polyethylene terephthalate which is at least region-wise annealed, at least one security element applied to the carrier film and at least one plastic film and shows optically faultless security elements.

Preferably in that respect the at least one plastic film is also formed from the same material as the carrier film.

A use of such a laminated layer composite in the form of a multi-layer card, in particular as a bank card, credit card, driving license or identity card, is ideal.

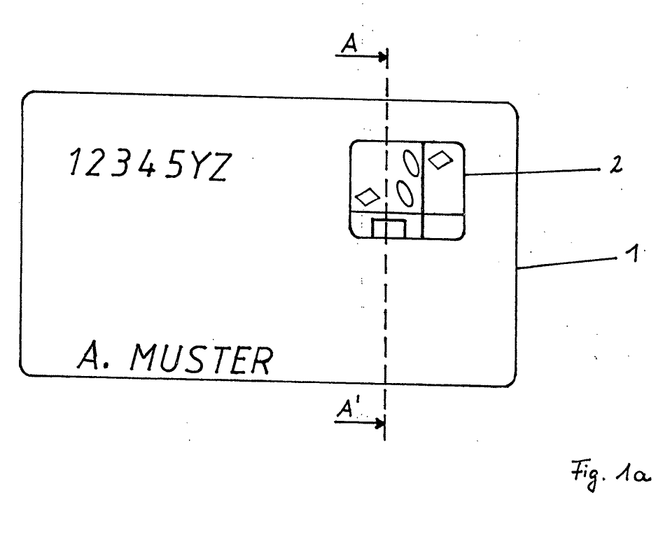

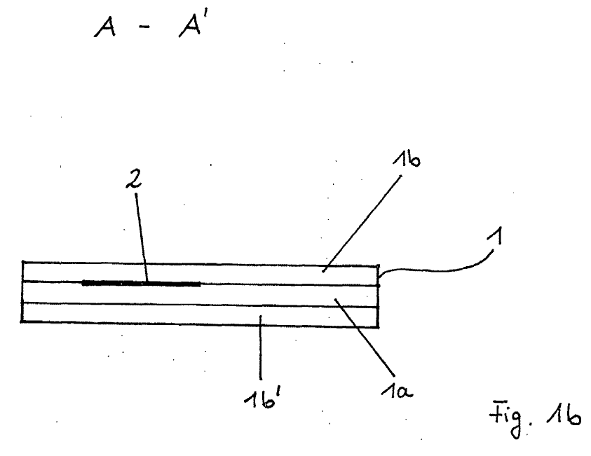

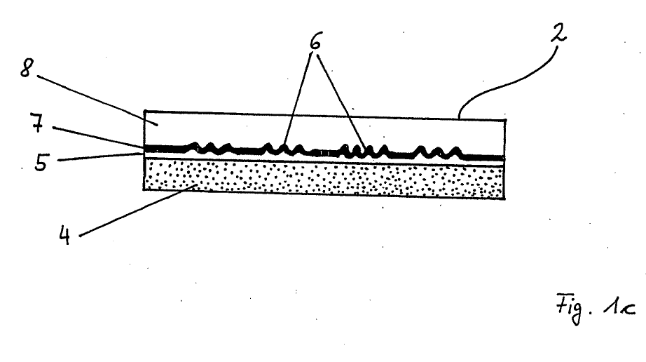

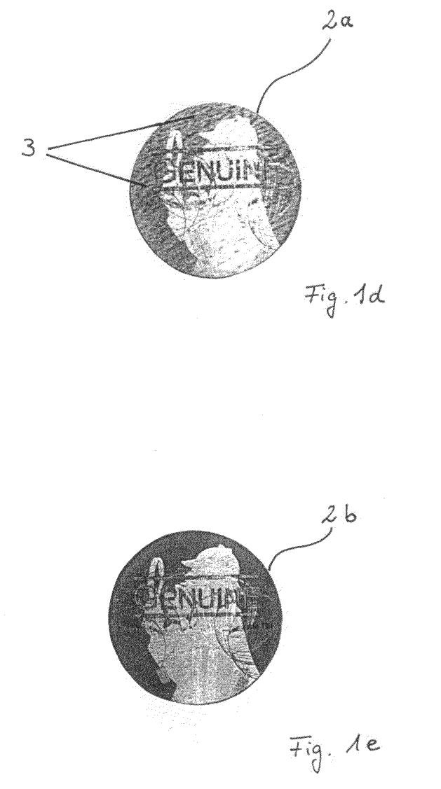

FIGS. 1a to 1e are intended to illustrate by way of example the process according to the invention by means of a structure selected by way of example of a laminated layer composite in card form and a security element. In the Figures:

FIG. 1a shows a laminated layer composite in card form including a security element,

FIG. 1b shows a cross-section A-A′ through the laminated layer composite of FIG. 1a at the level of the security element,

FIG. 1c shows a view in cross-section and on an enlarged scale of the structure of the security element of FIG. 1b,

FIG. 1d shows a security element with an orange peel effect, and

FIG. 1e shows the security element of FIG. 1d without the orange peel effect.

FIG. 1a shows a laminated layer composite 1 in card form including a security element 2. The security element 2 which is arranged only in a region of the layer composite 1 presents an optically variable effect which the viewing person can easily check. Besides the security element 2 the laminated layer composite 1 has an embossing in the form of a signature (A. Muster) and an identification number (12345YZ) which is formed by means of opaque printing ink on one of the layer portions of the layer composite 1 and is embedded in the latter.

FIG. 1b shows a cross-section A-A′ through the laminated layer composite 1 of FIG. 1a at the level of the security element 2. The security element 2 has been fixed on an annealed carrier film 1a of PVC by a hot embossing process, with the use of a conventional transfer film. The security element 2 which is released from the transfer layer portion of the transfer film is of a thickness of in total 6 μm. The carrier film 1a of PVC can be opaque or transparent. Here by way of example a transparent PVC film of the “clear matte core CV” type of a thickness of 650 μm from Lucchesi (IT) was used, which was annealed as follows prior to application of the security element 2:

The film of PVC in strip form was withdrawn from a supply roll and conveyed between heated rollers. In that case the PVC film was heated to 160° C., with an increase in pressure to 900 kN/m². After 240 seconds under those temperature and pressure conditions there was an increase in pressure to 2700 kN/m², wherein that pressure and the temperature of 160° C. at the PVC film were kept constant over a period of 240 seconds. Prior to that further increase in pressure it is alternatively possible to effect a relief of pressure on the heated film. In general in the meantime there can also be a brief relief of pressure on the heated film during the individual pressure increase or holding cycles. The PVC film was then relieved of pressure and cooled.

After cooling of the annealed PVC film or carrier film 1a to ambient temperature the security element 2 was partially embossed onto one side of the annealed carrier film 1a. After embossing of the security element 2 thereonto a first transparent plastic film 1b of PVC of a thickness of 75 μm was applied by lamination on the side of the annealed carrier film 1a, to which the security element 2 was applied. A second transparent plastic film 1b′ of PVC of a thickness of 75 μm was applied by lamination to the rear side of the carrier film 1a at the same time with the first transparent plastic film b or thereafter.

The security element 2 is visible for a viewing person through the first plastic film 1b and possibly also or alternatively through the second plastic film 1b′ and the carrier film 1a. The operation of laminating the carrier film 1a and the plastic films 1b, 1b′ was effected at a temperature of 160° C. and under a pressure of 900 kN/m² over a period of 4 minutes. By means of a few tests however the man skilled in the art is generally in a position to establish the possible or optimum laminating conditions for the respective layer composite.

FIG. 1c shows a view in cross-section and on an enlarged scale of the structure of the security element 2 of FIG. 1b. It is possible to see a hot adhesive layer 4 fixing the security element 2 to the annealed carrier film 1a (not shown here) of PVC. In addition the security element 2 has a bonding agent layer 5 and a crosslinked lacquer layer 8 which is highly transparent. A diffractive relief structure 6 is also shaped between the bonding agent layer 5 and the lacquer layer 8 and in addition an opaque metallic reflection layer 7 is arranged there over the full surface area. In this case by way of example the lacquer layer 8 is in the form of a crosslinked layer. It can however also be a non-crosslinked lacquer layer. If the bonding agent layer 5 and the adhesive layer 4 are transparent the optical effect of the security element 2 can be seen in laterally reversed relationship through the second plastic film 1b′ and the carrier film 1a.

FIG. 1d now shows a security element 2a, as is only diagrammatically indicated in FIG. 1a by reference 2, which is backed over its full surface area with an opaque metal layer and applied to a non-annealed carrier film of PVC and over-laminated with a plastic film of PVC in accordance with the above-mentioned laminating conditions. After the laminating operation the security element 2a has an orange peel effect 3 which adversely influences the optical appearance of the entire security element 2a, but in a copy particularly visibly in regions with a flat metal mirror (here the background region).

FIG. 1e shows a security element 2b, as is shown in FIG. 1d by reference 2a, which however is applied to a previously annealed carrier film of PVC and which was over-laminated with a plastic film of PVC in accordance with the above-mentioned laminating conditions. After the laminating operation the security element 2b does not present any orange peel effect and the optical appearance of the security element 2b is perfect (this can be seen in the copy in particular in direct comparison between the background regions of FIG. 1d and FIG. 1e).

For carrying out the process according to the invention the man skilled in the art has at his disposal a large number of further possible structures for the layer composite, film materials, annealing and laminating conditions which can be used and which respectively require only few tests to be used in accordance with the invention.

1-26. (canceled)

27. A process for the production of a laminated layer composite including a carrier film which has at least one polymer layer portion of polyvinyl chloride or polyethylene terephthalate, at least one security element applied to the at least one polymer layer portion, and at least one plastic film, wherein the carrier film is annealed prior to application of the security element at least in a region in which the security element is applied, wherein the carrier film and the at least one plastic film are laminated after application of the security element on the polymer layer portion to form the laminated layer composite and wherein a laminating step for the carrier film and the plastic film is effected at a temperature above a softening temperature of the at least one polymer layer portion.

28. A process according to claim 27, wherein the entire carrier film is annealed prior to application of the security element.

29. A process according to claim 27, wherein the carrier film is annealed at a temperature which is in a range of 10° C. below a softening temperature to above the softening temperature of the at least one polymer layer portion.

30. A process according to claim 27, wherein the carrier film is annealed at a temperature in the range of 100 to 160° C.

31. A process according to claim 27, wherein the carrier film is annealed under the action of pressure in the range of 500 to 4000 kN/m².

32. A process according to claim 27, wherein the carrier film is maintained at a temperature above a softening temperature of the at least one polymer layer portion at least in the region in which the security element is applied, at least over a period of 120 seconds.

33. A process according to claim 27, wherein the carrier film is annealed at a temperature which is below a softening temperature of the at least one polymer layer portion and in a range of up to 10° C. below the softening temperature of the at least one polymer layer portion.

34. A process according to claim 33, wherein the carrier film is kept at a temperature below the softening temperature of the at least one polymer layer portion and in a range of up to 10° C. below the softening temperature of the at least one polymer layer portion at least in the region in which the security element is applied, at least over a period of 120 seconds.

35. A process according to claim 27, wherein the at least one polymer layer portion of the carrier film is formed from PVC-P, PVC-U, PET, PEN, PET-G, PC, ABS or compounds of those plastic materials.

36. A process according to claim 27, wherein the carrier film is formed from a single polymer layer portion.

37. A process according to claim 27, wherein the carrier film is in the form of a composite comprising at least one polymer layer portion and paper and/or Teslin®.

38. A process according to claim 27, wherein the carrier film is of a thickness in the range of 12 μm to 1 mm.

39. A process according to claim 27, wherein the carrier film is cooled to a temperature in the range of 10° C. to 50° C. before the security element is applied.

40. A process according to claim 39, wherein the carrier film is cooled under the action of pressure in the range of 500 to 4000 kN/m².

41. A process according to claim 27, wherein the security element is applied by embossing, or by adhesive, to a first and/or a second side of the carrier.

42. A process according to claim 27, wherein the security element is applied to the carrier film in a thickness in the range of 3 μm to 100 μm.

43. A process according to claim 27, wherein the security element includes a plurality of layer portions which are provided by a transfer layer portion of a transfer film, and that the security element is transferred from the transfer film onto the carrier film.

44. A process according to claim 27, wherein the security element includes at least region-wise a metallic and/or a dielectric reflection layer.

45. A process according to claim 27, wherein the security element includes a diffractive relief structure, and/or includes an optically or optomagnetically machine-readable structure.

46. A process according to claim 45, wherein the security element includes at least two layer portions, between which the diffractive relief structure is embedded, and at least one of the at least two layer portions does not soften at the softening temperature of the polymer layer portion of the carrier film.

47. A process according to claim 27, wherein the at least one plastic film is laminated onto a first side and/or a second side of the carrier film.

48. A process according to claim 47, wherein the at least one plastic film is laminated at least onto the side of the carrier film to which the security element has been applied.

49. A process according to claim 27, wherein the at least one plastic film is formed from polyvinyl chloride, polyester, polyethylene terephthalate, polycarbonate, PETG, polyethylene naphthalate, ABS, polyethylene or compounds of those plastic materials.

50. A process according to claim 27, wherein a first plastic film is laminated onto a first side of the carrier film and a second plastic film is laminated onto a second side of the carrier film, wherein the first plastic film and the second plastic film are formed from the same material.

51. A laminated layer composite produced according to claim 27, including a carrier film of polyvinyl chloride or polyethylene terephthalate which is at least region-wise annealed, at least one security element applied to the carrier film and at least one plastic film.

52. Use of a laminated layer composite according to claim 51, as a multi-layer card.
